(19) United States
(12) Patent Application Publication
(10) Pub. No.: US 2025/0223480 A1
(43) Pub. Date: Jul. 10, 2025

(54) SALT-STORAGE ANTI-ICING COATING AND PREPARATION METHOD THEREOF

(71) Applicant: Xinjiang Suoying Technology Co., Ltd, Karamay (CN)

(72) Inventors: Jinghua WANG, Karamay (CN); Yuzhu ZHANG, Karamay (CN)

(21) Appl. No.: 18/642,645

(22) Filed: Apr. 22, 2024

(30) Foreign Application Priority Data
Jan. 4, 2024 (CN) 202410013341.6

(51) Int. Cl. C09K 3/18; C09K 103/00

(52) U.S. Cl. CPC C09K 3/18; C09K 2103/00

(57) ABSTRACT

The present disclosure provides a salt-storage anti-icing coating and a preparation method thereof, falling within the technical field of new materials for pavements. The salt-storage anti-icing coating is prepared by taking a slow-release salt-storage filler as a filler and an aqueous phase polyurethane energy storage material as a matrix material, and adding a thickening agent. In the present disclosure, combining the slow-release salt-storage filler technology and the phase-changing and temperature-regulating technology, the slow-release salt-storage filler lowers an ice point of pavement water, and the aqueous phase polyurethane energy storage material raises a pavement temperature by a phase-changing and temperature-regulating effect to achieve an anti-icing effect of pavements and improve an ice and snow removal effect.

### CROSS-REFERENCE TO RELATED APPLICATIONS

This application claims priority of Chinese Patent Application No. 202410013341.6, filed on Jan. 4, 2024, the entire contents of which are incorporated herein by reference.

### TECHNICAL FIELD

The present disclosure relates to the technical field of new materials for pavements, and in particular to a salt-storage anti-icing coating and a preparation method thereof.

### BACKGROUND

Pavement icing in winter not only affects traffic capacity, but also brings serious security risks to vehicles and pedestrians. In winter, the snow and ice on pavements make a skid resistance coefficient of the pavement decrease, and it is easy to cause braking failure and other problems to cause traffic accidents such as rear-end collision. In order to effectively remove frozen ice and improve the skid resistance of the pavement, a snowmelt agent is usually spread mechanically and manually to remove ice and snow. The manual removal method has a good removal effect, but is inefficient and consumes a lot of manpower and financial resources. The mechanical removal method can effectively remove snow from the pavement, but the mechanical equipment is expensive, and high in repair costs, and the equipment is prone to cause some damage to the pavement. A chemical snowmelt deicing agent method is mainly to lower an ice point of the pavement through the spreading of a snowmelt deicing agent to remove snow and ice from the pavement. The method is effective in removing snow and ice in winter. However, the application of the chemical snowmelt deicing agent method in winter snowfall or frozen rain weather requires timely spreading of the snowmelt deicing agent, consuming a lot of manpower and possibly causing traffic congestion. The above methods have the problem of untimely processing.

Compared with the traditional passive deicing technology, an active ice and snow removal technology is applied on salt-storage asphalt pavements. Salt dissolves in water in snow or ice, resulting in a salt concentration in the water to be raised, thereby lowering an ice point of the water. In this way, the snow melting effect can be achieved, and the use of chloride salt can also be greatly reduced, so that the snow melting becomes more effective and environmentally friendly. However, the addition of salt-storage anti-icing agent materials is still insufficient in terms of ice and snow removal effect for the salt-storage asphalt pavement.

### SUMMARY

In view of the above problems, the present disclosure provides a salt-storage anti-icing coating and a preparation method thereof. The salt-storage anti-icing coating combines the slow-release salt-storage filler technology and the phase-changing and temperature-regulating technology; and a slow-release salt-storage filler lowers an ice point of pavement water, and an aqueous phase polyurethane energy storage material raises a pavement temperature by a phase-changing and temperature-regulating effect to achieve an anti-icing effect of pavements and improve an ice and snow removal effect.

In order to achieve the objects, the present disclosure adopts the following technical solutions.

In a first aspect, the present disclosure provides a salt-storage anti-icing coating, prepared by taking a slow-release salt-storage filler as a filler and an aqueous phase polyurethane energy storage material as a matrix material, and adding a thickening agent,
an addition amount of the slow-release salt-storage filler being 10-20% of a mass of the matrix material, and an addition amount of the thickening agent being 0.5%-1.5% of the mass of the matrix material, and
the slow-release salt-storage filler being prepared by taking a volcanic rock or zeolite as a carrier, and adding a salt compound and a surfactant.

Hereinafter, as the preferred technical solutions of the present disclosure, but not as the limitation of the technical solutions provided by the present disclosure, it is better to achieve and realize the technical objects and beneficial effects of the present disclosure through the following technical solutions.

In one example of the present disclosure, the thickening agent is a BYK425 polyurethane rheological adjuvant.

In one example of the present disclosure, the salt compound is sodium chloride, calcium chloride, or magnesium chloride.

In one example of the present disclosure, the surfactant is span-40, span-60, or span-80.

In one example of the present disclosure, the slow-release salt-storage filler is prepared according to the following steps:
mixing the carrier, the salt compound and water to prepare a saturated solution with stirring at 55-65° C. to obtain a pasty mixture A, drying the pasty mixture A before being crushed to obtain powder; and
adding the surfactant into an organic solvent for uniform mixing, adding the powder for uniform mixing at 60-90° C. to obtain a mixed solution, drying the mixed solution before being crushed to obtain the slow-release salt-storage filler. In the drying process, a hydrophilic polar group of the surfactant is combined with the carrier, and a non-polar group is exposed, thereby achieving the hydrophobic effect.

In one example of the present disclosure, a stirring time is 7-9 h.

In one example of the present disclosure, a mass ratio of the carrier to the salt compound is 1:1-5.

In one example of the present disclosure, a mass ratio of the surfactant, the organic solvent and the powder is 1:1-10:1-10.

In one example of the present disclosure, a usage amount of the salt-storage anti-icing coating is 0.8-1.2 kg/m².

In a second aspect, the present disclosure provides a preparation method for a salt-storage anti-icing coating described above, including: dropwise adding ammonia water into an aqueous polyurethane emulsion to adjust a pH of a system to 7-8, adding a slow-release salt-storage filler with stirring for 25-30 min, and adding a thickening agent BYK425 with stirring for 20-30 min to obtain an anti-icing coating.

Compared with the prior art, the present disclosure has the following advantageous effects.

In the present disclosure, the anti-icing coating is prepared by taking the aqueous polyurethane energy storage material as the matrix material of the coating, and salt-storage particles as a functional filler of the coating. In an aspect of the present disclosure, the ice point of pavement water is lowered by the continuous precipitation of the salt compound. In another aspect, a cooling rate of the pavement is delayed and a minimum temperature of the pavement is raised through a phase-changing and temperature-regulating function of the aqueous phase polyurethane energy storage material, to achieve a double anti-icing effect, thereby improving the service property of pavement and prolonging the service life of pavement. In the prior art, a salt-storage asphalt mixture and a thermal storage pavement require salt-storage particles or phase-change particles to be directly incorporated into an asphalt mixture; and in contrast, the salt-storage anti-icing coating of the present disclosure does not affect the mechanical property of the asphalt mixture, and has advantages of easy construction, low cost and more obvious anti-icing effect.

### DETAILED DESCRIPTION

Technical solutions in the examples of the present disclosure will be described clearly and completely in the following with reference to the examples of the present disclosure. Obviously, all the described examples are only some, rather than all examples of the present disclosure. Based on the examples in the present disclosure, all other examples obtained by those skilled in the art without creative efforts belong to the scope of protection of the present disclosure . . . .

An active ice and snow removal technology is applied on salt-storage asphalt pavements. Salt dissolves in water in snow or ice, resulting in a salt concentration in the water to be raised, thereby lowering an ice point of the water. In this way, the snow melting effect can be achieved, and the use of chloride salt can also be greatly reduced, so that the snow melting becomes more effective and environmentally friendly.

In the prior art, for example, when a snow-melting and ice-suppressing asphalt mixture is prepared, in an ordinary asphalt mixture, a salt-storage anti-icing agent material can replace the corresponding components, thereby improving the ice-melting property of the asphalt mixture. However, the addition of salt-storage anti-icing agent material also has deficiencies in the effect of removing ice and snow for a salt-storage asphalt pavement.

Therefore, in the present disclosure, on the basis of the occurrence of the phase change of a phase change material when a temperature changes, with the absorption or release of a large amount of energy (latent heat of phase change), a temperature of a salt-storage anti-icing coating can be kept substantially constant, and the temperature regulation property of the coating can delay a cooling rate of the pavement, raise a minimum temperature of the pavement and alleviate the icing and frosting of the pavement. Polyurethane solid-solid phase change materials (PUPCMs) have advantages over organic solid-liquid phase change materials and other types of solid-solid phase change materials, such as no liquid or gas generated during phase change, the small volume change, the long service life and an adjustable phase change temperature.

In the present disclosure, an anti-icing coating is prepared by taking an aqueous polyurethane energy storage material as a matrix material of the coating and a slow-release salt-storage filler as a functional filler of the coating, and a salt-storage anti-icing coating can be obtained by adding a thickening agent BYK425 and stirring a mixture.

In the present disclosure, combining a salt-storage and anti-icing technology and a phase-changing and temperature-regulating technology, an ice point of pavement water is lowered by the salt-storage and anti-icing technology, and a pavement temperature is raised by a phase-changing and temperature-regulating effect, thereby achieving an anti-icing effect of pavements.

The thickening agent BYK425 used in the present disclosure is purchased from BYK Additives (Shanghai) Co., Ltd.

The aqueous polyurethane energy storage material used in the present disclosure is prepared according to the following steps.
(1) Polyethylene glycol (PEG) and dimethylolpropionic acid (DMPA) are dehydrated under vacuum at 110° C. for 4 h.
(2) 13 parts of isoflurone diisocyanate (IPDI) are placed in a three-neck flask, 15 parts of PEG are added, an appropriate amount of acetone (ACE) is added to adjust a viscosity of a system, and a mixture is stirred at a temperature of 40-70° C. for 1 h.
(3) 1.3 parts of DMPA are added, 0.1 parts of dibutyltin dilaurate (DBTDL) are added dropwise, and the reaction is carried out at a constant temperature of 40-70° C. for 1-4 h.
(4) A small molecule chain extender, butane-1,4-diol (BDO), is added and the chain extension is continued at a constant temperature for 0.5 h.
(5) A heating temperature is lowered to 20-60° C., and 0.8 parts of trimethylamine (TEA) are added, followed by stirring for 0.5 h.
(6) A stirring speed is increased and deionized water is slowly added to obtain an emulsion.
(7) ACE is distilled off under reduced pressure to obtain an aqueous polyurethane energy storage material.

The materials used in the present disclosure are as follows: IPDI purchased from Evonik Specialty Chemicals (Shanghai) Co., Ltd.; PEG purchased from Tianjin Kemiou Chemical Reagent Co., Ltd.; DMPA purchased from Shanghai Aladdin Biochemical Technology Co., Ltd.; DBTDL purchased from Tianjin Damao Chemical Reagent Factory; BDO purchased from Tianjin Kaitong Chemical Reagent Co., Ltd.; TEA purchased from Tianjin Kaitong Chemical Reagent Co., Ltd.; and ACE purchased from Shanghai Aladdin Biochemical Technology Co., Ltd.

The slow-release salt-storage filler used in the present disclosure is prepared by taking a volcanic rock or zeolite as a carrier, and adding a salt compound and a hydrophobic treatment agent. The steps for preparing the slow-release salt-storage filler are as follows.
(1) Distilled water is added to 1 part of the carrier and 4 parts of the salt compound until a solution is saturated, and the solution is stirred at a temperature of 55° C.-65° C. for 7-9 h to obtain a pasty mixture.
(2) The pasty mixture is dried to a constant weight at 130-140° C., and the dried material is crushed until all pass through a square-hole sieve with a fineness of 0.6 mm to obtain powder with a fineness of 0.6 mm or less.
(3) 0.5 parts of the hydrophobic treatment agent are added into a solvent and mixed uniformly at room temperature under sealed and stirred conditions, and the powder with a fineness of 0.6 mm or less is added, followed by stirring uniformly at a temperature of 45-55° C. to obtain a mixture.
(4) the obtained mixture is dried at a temperature of 35° C.-45° C. for 2 h, then placed at room temperature for 30 min, dried to a constant weight at a temperature of 130-140° C., and finally crushed until all pass through the square-hole sieve with a fineness of 0.6 mm to obtain the slow-release salt-storage filler.

The hydrophobic treatment agent used in the present disclosure is a permeable silicone resin.

The following is further illustrated by reference to specific examples. In the following specific examples, all raw materials are commercially available unless otherwise indicated.

### Example 1

The example provides a salt-storage-based anti-icing coating, prepared according to the following steps.

In step 1: an aqueous polyurethane energy storage material was prepared.

PEG and DMPA were dehydrated under vacuum at 110° C. for 4 h.

130 g of IPDI was placed in a three-neck flask, 150 g of PEG was added, 10 g of ACE was added to adjust a viscosity of a system, and a mixture was stirred at 60° C. for 1 h. 13 g of DMPA was added, 1 g of DBTDL was added dropwise, and the reaction was carried out at a constant temperature of 60° C. for 2 h. 14 g of small molecular chain extender BDO was added, and the chain extension was continued at a constant temperature for 0.5 h. A heating temperature was lowered to 40° C., and 8 g of TEA was added, followed by stirring for 0.5 h. A stirring speed was increased, and 700 g of deionized water was slowly added to obtain an emulsion. ACE was distilled off under reduced pressure to obtain the aqueous polyurethane energy storage material.

In step 2: a slow-release salt-storage filler was prepared.

10 g of the dried volcanic rock carrier and 40 g of salt compound, sodium chloride, were put into a vessel, 110 g of distilled water was added until a solution was saturated, and the solution was stirred at a temperature of 60° C. for 8 h to obtain a pasty mixture. The pasty mixture was dried to a constant weight at 135° C., and the dried material was crushed until all passed through a square-hole sieve with a fineness of 0.6 mm to obtain powder with a fineness of 0.6 mm or less.

10 g of surfactant span-80 was added to 50 g of ethanol solvent, followed by stirring for 1 h to fully dissolve the surfactant. 50 g of the powder with a fineness of 0.6 mm or less was added, followed by stirring at a temperature of 80° C. for 6 h before being dried to a constant weight at a temperature of 135° C., and finally the dried mixture was crushed until all passed through the square-hole sieve with a fineness of 0.6 mm to obtain the slow-release salt-storage filler.

In step 3: the salt-storage-based anti-icing coating was prepared.

A rotational speed of a shearing machine was controlled to be 400 r/min, and ammonia water was added dropwise into the aqueous polyurethane energy storage material to adjust a pH of a system to 7. A rotational speed was increased to 500 r/min, the slow-release salt-storage filler was added, followed by stirring for 30 min, and a thickening agent BYK425 was added, followed by stirring for 20 min to obtain an anti-icing coating.

In the example, an addition amount of the slow-release salt-storage filler was 20% of a mass of a matrix material, and an addition amount of the thickening agent was 1% of the mass of the matrix material.

An AC-13 asphalt mixture specimen of 30 cm×30 cm×5 cm was coated with the salt-storage anti-icing coating prepared in the example in a coating amount of 0.8 kg/m².

### Example 2

The example provides a salt-storage-based anti-icing coating, prepared according to the following steps.

In step 1: an aqueous polyurethane energy storage material was prepared.

PEG and DMPA were dehydrated under vacuum at 110° C. for 4 h.

130 g of IPDI was placed in a three-neck flask, 150 g of PEG was added, 10 g of ACE was added to adjust a viscosity of a system, and a mixture was stirred at 60° C. for 1 h. 13 g of DMPA was added, 1 g of DBTDL was added dropwise, and the reaction was carried out at a constant temperature of 60° C. for 2 h. 14 g of small molecular chain extender BDO was added, and the chain extension was continued at a constant temperature for 0.5 h. A heating temperature was lowered to 40° C., and 8 g of TEA was added, followed by stirring for 0.5 h. A stirring speed was increased, and 700 g of deionized water was slowly added to obtain an emulsion. ACE was distilled off under reduced pressure to obtain the aqueous polyurethane energy storage material.

In step 2: a slow-release salt-storage filler was prepared.

10 g of the dried volcanic rock carrier and 40 g of salt compound, sodium chloride, were put into a vessel, 110 g of distilled water was added until a solution was saturated, and the solution was stirred at a temperature of 60° C. for 8 h to obtain a pasty mixture. The pasty mixture was dried to a constant weight at 135° C., and the dried material was crushed until all passed through a square-hole sieve with a fineness of 0.6 mm to obtain powder with a fineness of 0.6 mm or less.

10 g of surfactant span-80 was added to 50 g of ethanol solvent, followed by stirring for 1 h to fully dissolve the surfactant. 50 g of the powder with a fineness of 0.6 mm or less was added, followed by stirring at a temperature of 80° C. for 6 h before being dried to a constant weight at a temperature of 135° C., and finally the dried mixture was crushed until all passed through the square-hole sieve with a fineness of 0.6 mm to obtain the slow-release salt-storage filler.

In step 3: the salt-storage-based anti-icing coating was prepared.

A rotational speed of a shearing machine was controlled to be 400 r/min, and ammonia water was added dropwise into the aqueous polyurethane energy storage material to adjust a pH of a system to 7. A rotational speed was increased to 500 r/min, the slow-release salt-storage filler was added, followed by stirring for 30 min, and a thickening agent BYK425 was added, followed by stirring for 20 min to obtain an anti-icing coating.

In the example, an addition amount of the slow-release salt-storage filler was 20% of a mass of a matrix material, and an addition amount of the thickening agent was 1% of the mass of the matrix material.

An AC-13 asphalt mixture specimen of 30 cm×30 cm×5 cm was coated with the salt-storage anti-icing coating prepared in the example in a coating amount of 1 kg/m².

### Example 3

The example provides a salt-storage-based anti-icing coating, prepared according to the following steps.

In step 1: an aqueous polyurethane energy storage material was prepared.

PEG and DMPA were dehydrated under vacuum at 110° C. for 4 h.

130 g of IPDI was placed in a three-neck flask, 150 g of PEG was added, 10 g of ACE was added to adjust a viscosity of a system, and a mixture was stirred at 60° C. for 1 h. 13 g of DMPA was added, 1 g of DBTDL was added dropwise, and the reaction was carried out at a constant temperature of 60° C. for 2 h. 14 g of small molecular chain extender BDO was added, and the chain extension was continued at a constant temperature for 0.5 h. A heating temperature was lowered to 40° C., and 8 g of TEA was added, followed by stirring for 0.5 h. A stirring speed was increased, and 700 g of deionized water was slowly added to obtain an emulsion. ACE was distilled off under reduced pressure to obtain the aqueous polyurethane energy storage material.

In step 2: a slow-release salt-storage filler was prepared.

10 g of the dried volcanic rock carrier and 40 g of salt compound, sodium chloride, were put into a vessel, 110 g of distilled water was added until a solution was saturated, and the solution was stirred at a temperature of 60° C. for 8 h to obtain a pasty mixture. The pasty mixture was dried to a constant weight at 135° C., and the dried material was crushed until all passed through a square-hole sieve with a fineness of 0.6 mm to obtain powder with a fineness of 0.6 mm or less.

10 g of surfactant span-80 was added to 50 g of ethanol solvent, followed by stirring for 1 h to fully dissolve the surfactant. 50 g of the powder with a fineness of 0.6 mm or less was added, followed by stirring at a temperature of 80° C. for 6 h before being dried to a constant weight at a temperature of 135° C., and finally the dried mixture was crushed until all passed through the square-hole sieve with a fineness of 0.6 mm to obtain the slow-release salt-storage filler.

In step 3: the salt-storage-based anti-icing coating was prepared.

A rotational speed of a shearing machine was controlled to be 400 r/min, and ammonia water was added dropwise into the aqueous polyurethane energy storage material to adjust a pH of a system to 7. A rotational speed was increased to 500 r/min, the slow-release salt-storage filler was added, followed by stirring for 30 min, and a thickening agent BYK425 was added, followed by stirring for 20 min to obtain an anti-icing coating.

In the example, an addition amount of the slow-release salt-storage filler was 20% of a mass of a matrix material, and an addition amount of the thickening agent was 1% of the mass of the matrix material.

An AC-13 asphalt mixture specimen of 30 cm×30 cm×5 cm was coated with the salt-storage anti-icing coating prepared in the example in a coating amount of 1.2 kg/m².

### Example 4

The example provides a salt-storage-based anti-icing coating, prepared according to the following steps.

In step 1: an aqueous polyurethane energy storage material was prepared.

PEG and DMPA were dehydrated under vacuum at 110° C. for 4 h.

130 g of IPDI was placed in a three-neck flask, 150 g of PEG was added, 10 g of ACE was added to adjust a viscosity of a system, and a mixture was stirred at 60° C. for 1 h. 13 g of DMPA was added, 1 g of DBTDL was added dropwise, and the reaction was carried out at a constant temperature of 60° C. for 2 h. 14 g of small molecular chain extender BDO was added, and the chain extension was continued at a constant temperature for 0.5 h. A heating temperature was lowered to 40° C., and 8 g of TEA was added, followed by stirring for 0.5 h. A stirring speed was increased, and 700 g of deionized water was slowly added to obtain an emulsion. ACE was distilled off under reduced pressure to obtain the aqueous polyurethane energy storage material.

In step 2: a slow-release salt-storage filler was prepared.

10 g of the dried volcanic rock carrier and 40 g of salt compound, sodium chloride, were put into a vessel, 110 g of distilled water was added until a solution was saturated, and the solution was stirred at a temperature of 60° C. for 8 h to obtain a pasty mixture. The pasty mixture was dried to a constant weight at 135° C., and the dried material was crushed until all passed through a square-hole sieve with a fineness of 0.6 mm to obtain powder with a fineness of 0.6 mm or less.

10 g of surfactant span-80 was added to 50 g of ethanol solvent, followed by stirring for 1 h to fully dissolve the surfactant. 50 g of the powder with a fineness of 0.6 mm or less was added, followed by stirring at a temperature of 80° C. for 6 h before being dried to a constant weight at a temperature of 135° C., and finally the dried mixture was crushed until all passed through the square-hole sieve with a fineness of 0.6 mm to obtain the slow-release salt-storage filler.

In step 3: the salt-storage-based anti-icing coating was prepared.

A rotational speed of a shearing machine was controlled to be 400 r/min, and ammonia water was added dropwise into the aqueous polyurethane energy storage material to adjust a pH of a system to 7. A rotational speed was increased to 500 r/min, the slow-release salt-storage filler was added, followed by stirring for 30 min, and a thickening agent BYK425 was added, followed by stirring for 20 min to obtain an anti-icing coating.

In the example, an addition amount of the slow-release salt-storage filler was 15% of a mass of a matrix material, and an addition amount of the thickening agent was 1% of the mass of the matrix material.

An AC-13 asphalt mixture specimen of 30 cm×30 cm×5 cm was coated with the salt-storage anti-icing coating prepared in the example in a coating amount of 1.2 kg/m².

### Example 5

The example provides a salt-storage-based anti-icing coating, prepared according to the following steps.

In step 1: an aqueous polyurethane energy storage material was prepared.

PEG and DMPA were dehydrated under vacuum at 110° C. for 4 h.

130 g of IPDI was placed in a three-neck flask, 150 g of PEG was added, 10 g of ACE was added to adjust a viscosity of a system, and a mixture was stirred at 60° C. for 1 h. 13 g of DMPA was added, 1 g of DBTDL was added dropwise, and the reaction was carried out at a constant temperature of 60° C. for 2 h. 14 g of small molecular chain extender BDO was added, and the chain extension was continued at a constant temperature for 0.5 h. A heating temperature was lowered to 40° C., and 8 g of TEA was added, followed by stirring for 0.5 h. A stirring speed was increased, and 700 g of deionized water was slowly added to obtain an emulsion. ACE was distilled off under reduced pressure to obtain the aqueous polyurethane energy storage material.

In step 2: a slow-release salt-storage filler was prepared.

10 g of the dried volcanic rock carrier and 40 g of salt compound, sodium chloride, were put into a vessel, 110 g of distilled water was added until a solution was saturated, and the solution was stirred at a temperature of 60° C. for 8 h to obtain a pasty mixture. The pasty mixture was dried to a constant weight at 135° C., and the dried material was crushed until all passed through a square-hole sieve with a fineness of 0.6 mm to obtain powder with a fineness of 0.6 mm or less.

10 g of surfactant span-80 was added to 50 g of ethanol solvent, followed by stirring for 1 h to fully dissolve the surfactant. 50 g of the powder with a fineness of 0.6 mm or less was added, followed by stirring at a temperature of 80° C. for 6 h before being dried to a constant weight at a temperature of 135° C., and finally the dried mixture was crushed until all passed through the square-hole sieve with a fineness of 0.6 mm to obtain the slow-release salt-storage filler.

In step 3: the salt-storage-based anti-icing coating was prepared.

A rotational speed of a shearing machine was controlled to be 430 r/min, and ammonia water was added dropwise into the aqueous polyurethane energy storage material to adjust a pH of a system to 7. A rotational speed was increased to 600 r/min, the slow-release salt-storage filler was added, and followed by stirring for 30 min, and a thickening agent BYK425 was added, followed by stirring for 20 min to obtain an anti-icing coating.

In the example, an addition amount of the slow-release salt-storage filler was 10% of a mass of a matrix material, and an addition amount of the thickening agent was 1% of the mass of the matrix material.

An AC-13 asphalt mixture specimen of 30 cm×30 cm×5 cm was coated with the salt-storage anti-icing coating prepared in the example in a coating amount of 1.2 kg/m².

### Example 6

The example provides a salt-storage-based anti-icing coating, prepared according to the following steps.

In step 1: an aqueous polyurethane energy storage material was prepared.

PEG and DMPA were dehydrated under vacuum at 110° C. for 4 h.

130 g of IPDI was placed in a three-neck flask, 150 g of PEG was added, 10 g of ACE was added to adjust a viscosity of a system, and a mixture was stirred at 60° C. for 1 h. 13 g of DMPA was added, 1 g of DBTDL was added dropwise, and the reaction was carried out at a constant temperature of 60° C. for 2 h. 14 g of small molecular chain extender BDO was added, and the chain extension was continued at a constant temperature for 0.5 h. A heating temperature was lowered to 40° C., and 8 g of TEA was added, followed by stirring for 0.5 h. A stirring speed was increased, and 700 g of deionized water was slowly added to obtain an emulsion. ACE was distilled off under reduced pressure to obtain the aqueous polyurethane energy storage material.

In step 2: a slow-release salt-storage filler was prepared.

10 g of the dried zeolite carrier and 10 g of salt compound, calcium chloride, were put into a vessel, 110 g of distilled water was added until a solution was saturated, and the solution was stirred at a temperature of 65° C. for 8 h to obtain a pasty mixture. The pasty mixture was dried to a constant weight at 135° C., and the dried material was crushed until all passed through a square-hole sieve with a fineness of 0.6 mm to obtain powder with a fineness of 0.6 mm or less.

10 g of surfactant span-40 was added to 10 g of ethanol solvent, followed by stirring for 1 h to fully dissolve the surfactant. 100 g of the powder with a fineness of 0.6 mm or less was added, followed by stirring at a temperature of 90° C. for 6 h before being dried to a constant weight at a temperature of 135° C., and finally the dried mixture was crushed until all passed through the square-hole sieve with a fineness of 0.6 mm to obtain the slow-release salt-storage filler.

In step 3: the salt-storage-based anti-icing coating was prepared.

A rotational speed of a shearing machine was controlled to be 450 r/min, and ammonia water was added dropwise into the aqueous polyurethane energy storage material to adjust a pH of a system to 8. A rotational speed was increased to 650 r/min, the slow-release salt-storage filler was added, followed by stirring for 25 min, and a thickening agent BYK425 was added, followed by stirring for 30 min to obtain an anti-icing coating.

In the example, an addition amount of the slow-release salt-storage filler was 20% of a mass of a matrix material, and an addition amount of the thickening agent was 0.5% of the mass of the matrix material.

### Example 7

The example provides a salt-storage-based anti-icing coating, prepared according to the following steps.

In step 1: an aqueous polyurethane energy storage material was prepared.

PEG and DMPA were dehydrated under vacuum at 110° C. for 4 h.

130 g of IPDI was placed in a three-neck flask, 150 g of PEG was added, 10 g of ACE was added to adjust a viscosity of a system, and a mixture was stirred at 60° C. for 1 h. 13 g of DMPA was added, 1 g of DBTDL was added dropwise, and the reaction was carried out at a constant temperature of 60° C. for 2 h. 14 g of small molecular chain extender BDO was added, and the chain extension was continued at a constant temperature for 0.5 h. A heating temperature was lowered to 40° C., and 8 g of TEA was added, followed by stirring for 0.5 h. A stirring speed was increased, and 700 g of deionized water was slowly added to obtain an emulsion. ACE was distilled off under reduced pressure to obtain the aqueous polyurethane energy storage material.

In step 2: a slow-release salt-storage filler was prepared.

10 g of the dried volcanic rock carrier and 100 g of salt compound, magnesium chloride, were put into a vessel, 110 g of distilled water was added until a solution was saturated, and the solution was stirred at a temperature of 55° C. for 8 h to obtain a pasty mixture. The pasty mixture was dried to a constant weight at 135° C., and the dried material was crushed until all passed through a square-hole sieve with a fineness of 0.6 mm to obtain powder with a fineness of 0.6 mm or less.

10 g of surfactant span-60 was added to 10 g of ethanol solvent, followed by stirring for 1 h to fully dissolve the surfactant. 50 g of the powder with a fineness of 0.6 mm or less was added, followed by stirring at a temperature of 60° C. for 6 h before being dried to a constant weight at a temperature of 135° C., and finally the dried mixture was crushed until all passed through the square-hole sieve with a fineness of 0.6 mm to obtain the slow-release salt-storage filler.

In step 3: the salt-storage-based anti-icing coating was prepared.

A rotational speed of a shearing machine was controlled to be 400 r/min, and ammonia water was added dropwise into the aqueous polyurethane energy storage material to adjust a pH of a system to 7. A rotational speed was increased to 500 r/min, the slow-release salt-storage filler was added, followed by stirring for 28 min, and a thickening agent BYK425 was added, followed by stirring for 25 min to obtain an anti-icing coating.

In the example, an addition amount of the slow-release salt-storage filler was 20% of a mass of a matrix material, and an addition amount of the thickening agent was 1.5% of the mass of the matrix material.

### Comparative Example 1

An asphalt was a matrix asphalt of KeLian (KL)-90, and limestone aggregate and limestone mineral powder were selected from limestone produced in Hechuan, Chongqing. The limestone aggregate and the limestone mineral powder have different particle sizes, a particle size of the limestone mineral powder being less than 0.6 mm. A gradation type of an asphalt mixture was AC-13, and a gradation pass rate of AC-13 mixture was shown in Table 1. An optimal asphalt-aggregate ratio was 4.9%. The asphalt-aggregate ratio is a percentage of a mass ratio of asphalt to mineral aggregate, which is composed of limestone aggregate and limestone mineral powder. A salt-storage anti-icing material was a slow-release salt-storage filler prepared in Example 1. The salt-storage anti-icing material was added to the asphalt mixture in the form of the equal volume replacement of 25% of mineral powder.

The aggregate was stirred at 175° C. for 90 s, then the asphalt was added to continue stirring for 90 s, and the mineral powder was added to stir for 90 s to obtain a salt-storage asphalt mixture.

TABLE 1
Gradation pass rate of AC-13 mixture

| | Particle size/mm | | | | | | | | | | | |
|---|---|---|---|---|---|---|---|---|---|---|---|---|
| | 26.5 | 19 | 16 | 13.2 | 9.5 | 4.75 | 2.36 | 1.18 | 0.6 | 0.3 | 0.15 | 0.075 |
| Pass | 100 | 100 | 100 | 97.62 | 83.31 | 54.42 | 40.73 | 26.31 | 17.07 | 9.03 | 6.40 | 4.49 |
| rate | | | | | | | | | | | | |

### Comparative Example 2

An asphalt was a matrix asphalt of KL-90, and limestone aggregate and limestone mineral powder were selected from limestone produced in Hechuan, Chongqing. The limestone aggregate and the limestone mineral powder have different particle sizes, a particle size of the limestone mineral powder being less than 0.6 mm. A gradation type of an asphalt mixture was AC-13, and a gradation pass rate of AC-13 mixture was shown in Table 1. An optimal asphalt-aggregate ratio was 4.9%. The asphalt-aggregate ratio is a percentage of a mass ratio of asphalt to mineral aggregate, which is composed of limestone aggregate and limestone mineral powder. A salt-storage anti-icing material was a slow-release salt-storage filler prepared in Example 1. The salt-storage anti-icing material was added to the asphalt mixture in the form of the equal volume replacement of 50% of mineral powder.

In an agitated kettle, the aggregate was added and stirred at 175° C. for 90 s, then the asphalt was added to continue stirring for 90 s, and the mineral powder was added to stir for 90 s to obtain a salt-storage asphalt mixture.

### Comparative Example 3

An asphalt was a matrix asphalt of KL-90, and limestone aggregate and limestone mineral powder were selected from limestone produced in Hechuan, Chongqing. The limestone aggregate and the limestone mineral powder have different particle sizes, a particle size of the limestone mineral powder being less than 0.6 mm. A gradation type of an asphalt mixture was AC-13, and a gradation pass rate of AC-13 mixture was shown in Table 1. An optimal asphalt-aggregate ratio was 4.9%. The asphalt-aggregate ratio is a percentage of a mass ratio of asphalt to mineral aggregate, which is composed of limestone aggregate and limestone mineral powder. A salt-storage anti-icing material was a slow-release salt-storage filler prepared in Example 1. The salt-storage anti-icing material was added to the asphalt mixture in the form of the equal volume replacement of 100% of mineral powder.

The aggregate was stirred at 175° C. for 90 s, then the asphalt was added to continue stirring for 90 s, and the mineral powder was added to stir for 90 s to obtain a salt-storage asphalt mixture.

Characterization tests were performed on the aqueous polyurethane energy storage material prepared in Example 1.

The thermal storage property of phase-change aqueous polyurethane was measured by DSC-200 of a differential scanning calorimeter (DSC) manufactured by NETZSCH (Germany). The tests were performed in a temperature range of −50° C.-60° C., a temperature-raising and cooling rate of 10° C./min and a nitrogen atmosphere. The test results are shown in Table 2.

TABLE 2
Thermal storage property of aqueous polyurethane energy storage material

| | Exothermic process | | | Endothermic process | | |
|---|---|---|---|---|---|---|
| | | Temperature | Temperature | | Temperature | Temperature |
| | Enthalpy | interval of | peak of | Enthalpy | interval of | peak of |
| | value of phase | phase | phase | value of phase | phase | phase |
| | change/(J · g⁻¹) | change/° C. | change/° C. | change/(J · g⁻¹) | change/° C. | change/° C. |
| Example | 46.8 | −2.7-−13.5 | −8.9 | 45.8 | 12.9-25.2 | 20.7 |
| 1 | | | | | | |

### Water Absorption Test

The aqueous polyurethane energy storage material was taken and weighed at room temperature, and immersed in deionized water for 24 h; and a filter paper was used to quickly absorb surface moisture of a coating film, and the aqueous polyurethane energy storage material was immediately weighed and a weight thereof was recorded.

### Curing Time Test

A curing time of the phase-change aqueous polyurethane was tested by a finger touch method. According to the CB/T23446-2009 standard, a surface drying time refers to a time when single-component polyurea has no adhesion from the beginning of coating to finger touch, and an actual drying time refers to a time from the beginning of coating to the complete removal from a mold of single-component polyurea, a coating thickness being 1.0 mm.

### Hardness Test

A hardness test was performed on the phase-change aqueous polyurethane by an LX-A type Shore durometer manufactured by Shanghai Hongsheng Industrial Instrument Co., Ltd. According to GB/T 6031-2017 for the test method, the hardness of vulcanized rubber or thermoplastic rubber with smooth surface was determined.

### Tensile Test

The tensile property of the phase-change aqueous polyurethane was tested by an XWW-20A universal mechanical testing machine manufactured by Chengde Jinjian Testing Instrument Co., Ltd. According to GB/T 2567-2008 for the test method, a tensile rate was 5 mm/min and a temperature was 25° C.

The basic property results of the aqueous polyurethane energy storage material are shown in Table 3.

TABLE 3
Basic properties of aqueous polyurethane energy storage material

| Test item | Test instrument or method | Test result |
|---|---|---|
| Surface drying time | CB/T23446-2009 | 4 |
| Actual drying time | CB/T23446-2009 | 10 |
| Appearance of film- | Visual inspection | Transparent |
| forming material | | and flat |
| Water stability | Water absorption/% | 4.59% |
| Hardness of film- | Shore durometer/Shore A | 93.4 |
| forming material | | |
| Enthalpy of phase | DSC | 50.4 |
| change | | |
| Tensile strength | GB/T 2567-2008 | 8.1 |
| Percentage of breaking | GB/T 2567-2008 | 251.4% |
| elongation | | |

It can be seen from Table 3 that the surface drying time and the actual drying time indicate that the curing time of polyurethane is suitable and convenient for construction. The hardness, tensile strength and percentage of breaking elongation indicate that the polyurethane has good mechanical properties. The enthalpy of phase change indicates that the polyurethane has good thermal storage property.

The slow-release salt-storage filler prepared in Example 1 was tested for water permeability and dissolution. The results are shown in Table 4.
(1) A bottom of a transparent disposable cup was treated.
(2) 20 g of powder was added for vibration compaction and leveling.
(3) 100 ml of distilled water was poured along a cup wall and a permeation time and a flow completion time were observed.
(4) For the filtrate or supernatant (the supernatant being taken for the water-impermeable or water-difficultly permeable powder), a chloride ion determination was performed by a chloride ion detector.

TABLE 4
Slow-release salt-storage filler prepared in Example 1

| Permeation | | Chloride ion concentration |
|---|---|---|
| time | pH value | (mol/L) |
| 2 d | 7 | 2.502 |

It can be seen from Table 4 that the slow-release salt-storage filler prepared in the present disclosure has a good hydrophobic effect.

In Examples 1-3, AC-13 asphalt mixture specimens of 30 cm×30 cm×5 cm were coated with salt-storage anti-icing coatings with different coating amounts (0.8 kg/m², 1 kg/m², and 1.2 kg/m²), and the property of a specimen without a salt-storage anti-icing coating was studied as a control group.

Wear-resisting property test: an effect of a coating brushing amount on the wear-resisting property of the salt-storage anti-icing coating was studied by a wear tester. A specimen size of the mixture was 30 cm×30 cm×5 cm. The wear tester was run with a vertical load of 0.7 MPa, a wheel width of 100 mm, and a rotational speed of 60 r/min for 8 h. The change of a mass of the specimen before and after the test was recorded, as shown in Table 5. It can be seen from Table 5 that the wear-resisting property of the coating reduces with the increase of the coating brushing amount and the increase of an incorporated content of the slow-release salt-storage filler, but the overall effect is not significant, which meets the requirements of the specification for the wear-resisting property of asphalt mixture.

TABLE 5
Effect of salt-storage anti-icing coating with different
coating amounts on wear-resisting property

| Test number | Mass loss (g) |
|---|---|
| Control group | 0.8 |
| Example 1 | 1.2 |
| Example 2 | 1.8 |
| Example 3 | 2.5 |
| Example 4 | 2.0 |
| Example 5 | 1.6 |

Anti-sliding property test: an effect of a coating brushing amount on the anti-sliding property of the salt-storage anti-icing coating was studied by a pendulum friction coefficient tester. A specimen size of the mixture was 30 cm×30 cm×5 cm. It can be seen from Table 6 that the anti-sliding property of the coating reduces with the increase of the coating brushing amount, and the anti-sliding property of the coating improves with the increase of an incorporated content of the slow-release salt-storage filler, but the overall effect is not significant, which meets the requirements of the specification for the anti-sliding property of asphalt mixture.

TABLE 6
Effect of salt-storage anti-icing coating with different
coating amounts on anti-sliding property

| | British pendulum number |
|---|---|
| Test number | (BPN) |
| Control group | 70 |
| Example 1 | 66 |
| Example 2 | 63 |
| Example 3 | 60 |
| Example 4 | 58 |
| Example 5 | 55 |

Slow release property test: the anti-icing coating was formed in a stainless steel container. 100 ml of deionized water was poured into the container, so that the anti-icing coating specimen was completely immersed in the deionized water, taking two days as a test cycle. A percentage of single release on the tenth day was calculated, and the results are shown in Table 7. It can be seen from Table 7 that the slow release property of the salt-storage anti-icing coating improves with the increase of an incorporated content of the slow-release salt-storage filler, and the salt-storage anti-icing coating has a longer effective action time, so that it has good deicing function and durability.

TABLE 7
Effect of salt-storage anti-icing coating with different
coating amounts on slow release property

| | Release percentage of effective |
|---|---|
| Test number | components (%) |
| Control group | 0 |
| Example 1 | 5.22 |
| Example 2 | 5.34 |
| Example 3 | 5.89 |
| Example 4 | 5.65 |
| Example 5 | 5.45 |

Temperature regulating property test: a late heat accumulated temperature value (LHATV) and a latent heat thermoregulation index (LHTI) including a temperature difference and a time change process were selected to evaluate the temperature regulating property of the anti-icing coating. The temperature regulating property was measured after the anti-icing coating was placed in an environmental box at a constant temperature of 40° C. for 5 h, and a temperature of the environmental box was adjusted to reduce to −35° C. at a rated rate of 2° C./min. When a temperature of specimen reached −35° C., a temperature of the environmental box was adjusted to raise to 40° C. at a rated rate of 2° C./min; and when a temperature of specimen reached 40° C., the test was finished. LHATV is an accumulated value of a temperature difference with time in a whole process of latent heat of phase change or a period of time in the whole process of the anti-icing coating, and characterizes a magnitude of the temperature regulation ability of the anti-icing coating; and LHTI represents a degree to which a phase change material completes the latent heat of phase change under unit time and unit temperature change, and can characterize the latent heat temperature regulation efficiency of the anti-icing coating at a certain temperature or period of time. It can be seen from Table 6 that in a cooling process, the anti-icing coating has an exothermic temperature interval from 0° C. to −15° C., and has a higher LHATV and LHTI, indicating that the anti-icing coating can release a large amount of latent heat in a low-temperature environment, effectively shortening a low-temperature action time of the pavement and raising a valley temperature of the pavement, thereby achieving the anti-icing effect.

The anti-icing coating fills voids on the surface of the mixture, reducing a structural depth of the pavement. In addition, the coating prepared by the present disclosure has a dense coating film formed by crosslinking and curing, which is smoother than a surface of the asphalt mixture, reducing the friction between the pavement and the tire, so that the anti-sliding property of the pavement reduces with the increase of the coating brushing amount. The addition of slow-release salt-storage filler improves the roughness of the coating surface, so the anti-sliding property of the coating reduces with the decrease of an incorporated content of the slow-release salt filler. In general, a BPN of Example 5 is the smallest, but also much higher than the specification (BPN≥45). The aqueous polyurethane energy storage material prepared in this study has better anti-sliding property.

The addition of slow-release salt-storage filler improves the roughness of the coating surface, resulting in the enhanced interaction between a wheel and a surface of the specimen and the reduction of wear-resisting property. An aqueous polyurethane coating has a relatively low hardness and elasticity modulus, and scratches and wear are more likely to occur in a wear test. Therefore, the wear-resisting property of pavement reduces with the increase of the coating brushing amount and an incorporated content of the slow-release salt-storage filler. In general, a mass loss of Example 3 is the largest, which only accounts for 0.019% of a total mass of rutting plates. The aqueous polyurethane energy storage material prepared in this study has better wear-resisting property.

The slow release property of the salt-storage anti-icing coating is mainly related to the selection of a carrier and surfactant of the slow-release salt-storage filler, so the slow release property of each of the examples is not greatly different. When the content of slow-release salt-storage filler is higher, a release rate of effective components increases slightly.

A temperature regulating effect of the anti-icing coating depends on a phase-changing and temperature-controlling effect of aqueous polyurethane, so the greater the amount of an aqueous polyurethane coating, the better the temperature regulating effect.

TABLE 8
Calculation results of temperature regulation indexes of anti-icing coating

| Temperature | | | | Time | Temperature | | |
|---|---|---|---|---|---|---|---|
| regulation | | Time | Temperature | domain/ | domain/ | LHATV/ | |
| process | Label | zone/s | zone/° C. | s | ° C. | (° C. · s) | LHTI |
| Temperature- | Example | 5010-6870 | 13.4-24.7 | 1860 | 11.3 | 540.0 | 0.026 |
| raising period | 1 | | | | | | |
| | Example | 4920-6900 | 12.0-23.9 | 1980 | 11.9 | 1032.0 | 0.044 |
| | 2 | | | | | | |
| | Example | 4950-6930 | 12.3-23.4 | 1980 | 11.1 | 1980.2 | 0.090 |
| | 3 | | | | | | |
| | Example | 4960-6940 | 12.2-23.2 | 1980 | 11.0 | 1995.2 | 0.091 |
| | 4 | | | | | | |
| | Example | 4980-6960 | 12.4-23.3 | 1980 | 10.9 | 2012.5 | 0.093 |
| | 5 | | | | | | |
| Cooling | Example | 4170-5610 | 0.5-−14.8 | 1440 | 15.3 | 539.5 | 0.024 |
| period | 1 | | | | | | |
| | Example | 4200-5610 | 1.0-−13.4 | 1410 | 14.4 | 982.5 | 0.048 |
| | 2 | | | | | | |
| | Example | 4170-5580 | 1.0-−13.0 | 1410 | 14.0 | 1744.5 | 0.089 |
| | 3 | | | | | | |
| | Example | 4175-5580 | 1.2-−13.2 | 1405 | 14.0 | 1755.5 | 0.092 |
| | 4 | | | | | | |
| | Example | 4180-5585 | 1.1-−13.3 | 1405 | 14.4 | 1768.8 | 0.094 |
| | 5 | | | | | | |

Under different snowfall conditions (Table 9), an anti-frost property test was performed on the salt-storage anti-icing coating of the present disclosure. The results are shown in Tables 10-11.

TABLE 9
Snowfall conditions

Snowfall condition

| | Light | Moderate | Heavy | |
|---|---|---|---|---|
| | snow | snow | snow | Snowstorm |
| Precipitation | <1 | 1-3 | 3-6 | >6 |
| (mm/12 h) | | | | |

TABLE 10
Anti-frost property of anti-icing coating

Anti-frost temperature

| | Light | Moderate | Heavy | |
|---|---|---|---|---|
| Label | snow | snow | snow | Snowstorm |
| Example 1 | −2.9 | −1.9 | −0.7 | −0.2 |
| Example 2 | −3.8 | −2.9 | −0.9 | −0.5 |
| Example 3 | −5.2 | −3.6 | −1.2 | −0.8 |
| Example 4 | −4.4 | −3.2 | −1.0 | −0.7 |
| Example 5 | −3.6 | −2.7 | −0.8 | −0.6 |
| Control group | −0.2 | −0.1 | −0.1 | 0 |
| Comparative | −1.2 | −0.6 | −0.2 | −0.1 |
| Example 1 | | | | |
| Comparative | −1.9 | −1.1 | −0.4 | −0.1 |
| Example 2 | | | | |
| Comparative | −2.8 | −1.8 | −0.6 | −0.2 |
| Example 3 | | | | |

TABLE 11
Freezing property of anti-icing coating

Freezing time

| | Light | Moderate | Heavy | |
|---|---|---|---|---|
| Label | snow | snow | snow | Snowstorm |
| Example 1 | 3.6 | 2.4 | 0.9 | 0.3 |
| Example 2 | 4.5 | 3.0 | 1.2 | 0.4 |
| Example 3 | 5.6 | 3.8 | 1.4 | 0.5 |
| Example 4 | 4.9 | 3.3 | 1.2 | 0.4 |
| Example 5 | 4.2 | 2.7 | 1.0 | 0.3 |
| Control group | 0.5 | 0.3 | 0.2 | 0.1 |
| Comparative | 1.4 | 0.9 | 0.4 | 0.2 |
| Example 1 | | | | |
| Comparative | 2.2 | 1.5 | 0.6 | 0.2 |
| Example 2 | | | | |
| Comparative | 3.3 | 2.2 | 0.8 | 0.3 |
| Example 3 | | | | |

It can be seen from Tables 9 and 10 that an anti-frost temperature of the pavement can be significantly reduced and a freezing time can be prolonged through the salt-storage anti-icing coating prepared by the present disclosure. Compared with the salt-storage asphalt mixture, the anti-icing effect of the salt-storage anti-icing coating is more significant. The application of the coating can reduce the use of snow-melting salt, and alleviate the harm to pavement and environment, with convenient maintenance and repair. This is because compared with the salt-storage asphalt mixture, the salt-storage anti-icing coating can not only lower the ice point of pavement water, but also raise the pavement temperature through the phase-changing and temperature-regulating effect of the aqueous polyurethane energy storage material, making the coating have a double anti-icing effect. In addition, the salt-storage anti-icing coating directly acts on the lowest temperature of asphalt pavement structure, so it can maximize the anti-icing effect.

While the preferred examples of the present disclosure have been described, additional variations and modifications to these examples can be made by those skilled in the art once the basic inventive concept is known. Therefore, the appended claims are intended to be interpreted as including the preferred example and all changes and modifications that fall within the scope of the present disclosure.

Obviously, those skilled in the art can make various modifications and variations to the present disclosure without departing from the spirit and scope of the present disclosure. Therefore, it is intended that the present disclosure cover the modifications and variations of the present disclosure provided that the modifications and variations are within the scope of the appended claims and equivalents.

1. A salt-storage anti-icing coating, prepared by taking a slow-release salt-storage filler as a filler and an aqueous phase polyurethane energy storage material as a matrix material, and adding a thickening agent,
an addition amount of the slow-release salt-storage filler being 10-20% of a mass of the matrix material, and an addition amount of the thickening agent being 0.5%-1.5% of the mass of the matrix material, and
the slow-release salt-storage filler being prepared by taking a volcanic rock or zeolite as a carrier, and adding a salt compound and a surfactant.

2. The salt-storage anti-icing coating according to claim 1, wherein the thickening agent is a BYK425 polyurethane rheological adjuvant.

3. The salt-storage anti-icing coating according to claim 1, wherein the salt compound is sodium chloride, calcium chloride, or magnesium chloride.

4. The salt-storage anti-icing coating according to claim 1, wherein the surfactant is span-40, span-60, or span-80.

5. The salt-storage anti-icing coating according to claim 1, wherein the slow-release salt-storage filler is prepared according to the following steps:
mixing the carrier, the salt compound and water to prepare a saturated solution with stirring at 55-65° C. to obtain a pasty mixture A, drying the pasty mixture A before being crushed to obtain powder; and
adding the surfactant into an organic solvent for uniform mixing, adding the powder for uniform mixing at 60-90° C. to obtain a mixed solution, drying the mixed solution before being crushed to obtain the slow-release salt-storage filler.

6. The salt-storage anti-icing coating according to claim 5, wherein a stirring time is 7-9 h.

7. The salt-storage anti-icing coating according to claim 5, wherein a mass ratio of the carrier to the salt compound is 1:1-5.

8. The salt-storage anti-icing coating according to claim 5, wherein a mass ratio of the surfactant, the organic solvent and the powder is 1:1-10:1-10.

9. The salt-storage anti-icing coating according to claim 1, wherein a usage amount of the salt-storage anti-icing coating is 0.8-1.2 kg/m².

10. A preparation method for a salt-storage anti-icing coating according to claim 1, comprising: dropwise adding ammonia water into an aqueous polyurethane emulsion to adjust a pH of a system to 7-8, adding a slow-release salt-storage filler with stirring for 25-30 min, and adding a thickening agent BYK425 with stirring for 20-30 min to obtain an anti-icing coating.

11. A preparation method for a salt-storage anti-icing coating according to claim 5, comprising: dropwise adding ammonia water into an aqueous polyurethane emulsion to adjust a pH of a system to 7-8, adding a slow-release salt-storage filler with stirring for 25-30 min, and adding a thickening agent BYK425 with stirring for 20-30 min to obtain an anti-icing coating.
